(19) United States
(12) Patent Application Publication
(10) Pub. No.: US 2019/0338999 A1
(43) Pub. Date: Nov. 7, 2019

(54) DEVICE FOR LOCKING A HOME BAR DOOR OF REFRIGERATOR

(71) Applicant: Daewoo Electronics Co., Ltd., Gwangju (KR)

(72) Inventor: Wang-Koo LEE, Incheon (KR)

(21) Appl. No.: 16/234,079

(22) Filed: Dec. 27, 2018

(30) Foreign Application Priority Data
May 2, 2018 (KR) 10-2018-0050789

(51) Int. Cl. F25D 23/02; E05C 1/12; E05B 65/06

(52) U.S. Cl. CPC F25D 23/025; E05C 1/12; E05Y 2900/31; F25D 2323/023; E05B 65/06

(57) ABSTRACT

Embodiments of the present invention relate to a device for locking a home bar door of a refrigerator appliance. More particularly, embodiments of the present invention relate to a device for locking a home bar door of a refrigerator, where the device employs a simple cam sliding mechanism to open a home bar door in a stable fashion. The device according to an embodiment of the present invention includes: a latch part mounted on a refrigerator door and having a locking block configured to be linearly movable in the latch part; and a release part mounted on a home bar door hinged to an opening provided in the refrigerator door, where the release part operates the latch part to move linearly, and is detachably engaged with the latch part.

### CROSS REFERENCE TO RELATED APPLICATION

This application claims the benefit of Korean Patent Application No. 10-2018-0050789, filed May 2, 2018, which is hereby incorporated by reference in its entirety into this application.

### BACKGROUND OF THE INVENTION

### 1. Technical Field

Embodiments of the present invention relate to a device for locking a home bar door of a refrigerator appliance. More particularly, the present invention relates to a device for locking a home bar door of a refrigerator appliance, where the device includes a mechanical component.

### 2. Description of the Related Art

A refrigerator is an appliance for storing various food items in a fresh state. For this purpose, the refrigerator utilizes a refrigeration cycle in which a refrigerant is compressed, condensed, expanded, and evaporated, over these cycles, to lower the internal temperature of the refrigerator.

In general, the refrigerator has a freezer compartment for maintaining a subzero temperature to freeze and to store food items, and also has a refrigerator compartment, which maintains a temperature lower than room temperature to maintain food freshness without freezing.

Recently, as shown in FIG. 1, a refrigerator type has become available that contains a home bar 4 that allows frequently used beverages to be easily taken out, served, and stored again without opening the main door 2 of the refrigerator 1.

For opening and closing the home bar 4, a home bar door 14 is provided which is an auxiliary door built in the main door. The home bar door 14 includes a latch member provided on the refrigerator door 2 and a locking device provided as a locking member and mounted on the home bar door 14 to engage with the latch member.

A conventional locking device employs a rotary cam, which is a complicated structure, and thus this locking device is incompatible with a home bar door that requires a constant stroke operation, thereby making this conventional locking device non-optimal and also having high manufacturing costs. When assembling the home bar door, and when considering the entire assembly steps and parts required to make the refrigerator, many assembly deviations may occur and are expected. Particularly, deviations that cause the home bar door to be bent, or the refrigerator door to shrink or bend, may interfere with smooth opening and closing operations of the home bar door thereby reducing the perceived quality of the appliance.

Therefore, in order to solve the above-mentioned problems, there is a need to develop an improved device for locking a home bar door of a refrigerator, where the device is able to smoothly and easily open and close the home bar door while also employing a simple mechanism.

### SUMMARY OF THE INVENTION

Accordingly, the embodiments of the present invention have been made keeping in mind the above problems occurring in the related art, and an object of the present invention is to provide a device for locking a home bar door of a refrigerator where the device also opens and closes the home bar door smoothly, easily and reliably and in a stable fashion.

In addition, another object of the present invention is to provide a device for locking a home bar door of a refrigerator where the device has a simple operational mechanism and securely locks the home bar door.

In addition, a further object of the present invention is to provide a device for locking a home bar door of a refrigerator where the device reduces manufacturing costs versus the prior art mechanisms.

Furthermore, still another object of the present invention is to provide a device for locking a home bar door of a refrigerator where the device eliminates problems associated with opening and closing operations which problems may occur due to assembly deviations encountered during the appliance assembly process.

The objects of the present invention are not limited only to the objects described above. Accordingly, additional objects of the present invention will be set forth in part in the description which follows and in part will become apparent to those having ordinary skill in the art upon examination of the following or may be learned from practice of the present invention.

The embodiments of the present invention that achieve the objects of the present invention, as described above, and which implement the characteristic functions of the present invention are described below.

According to an embodiment of the present invention, a device for locking a home bar door of a refrigerator is provided, where the device includes: a latch part mounted on a refrigerator door and having a locking block configured to be linearly movable in the latch part; and a release part mounted on a home bar door hinged to an opening provided in the refrigerator door, the release part causing the latch part to move linearly, and being detachably engaged with the latch part.

The locking block may be mounted in such a way as to move linearly or move vertically.

The latch part may further include a cam member for linearly moving the locking block by pressing thereof.

The release part may further include an engaging portion detachably engaged with the locking block.

The locking block may further include a grip configured to engage with the engaging portion.

The latch part may further include an elastic member configured to restore a position of the locking block when a depress is released.

The release part may further include a pin member contacting to the cam member to press the cam member.

According to an embodiment of the present invention, a device for locking a home bar door of a refrigerator is provided, where the device includes: a latch part mounted on a refrigerator door; and a release part mounted on a home bar door that is hinged to an opening provided in the refrigerator door. In addition, the latch part includes: a locking block configured to be linearly movable; a cam member contacting the locking block and linearly moving the locking block in response to a pressing action; and an elastic member restoring a position of the locking block when a depress thereof is released. In addition, the release part includes: a pin member contacting the cam member to press the cam member; and an engaging portion that is detachably engaged with the locking block.

The cam member and the locking block may move in directions that are perpendicular to each other.

The locking block may further include: a contact surface contacting the cam member; and a grip configured to engage with the engaging portion.

According to an embodiment of the present invention, a device for locking a home bar door of a refrigerator is provided where the device allows stable opening and closing of the home bar door.

According to an embodiment of the present invention, a device for locking a home bar door of a refrigerator is described where the device has a simple operational mechanism to securely lock the home bar door.

According to an embodiment of the present invention, a device for locking a home bar door of a refrigerator is described that reduces manufacturing costs.

According to an embodiment of the present invention, a device for locking a home bar door of a refrigerator is described that eliminates obstacles encountered when opening and closing the door, which problems may occur due to assembly deviations during an assembly process of the appliance.

The effects of the present invention are not limited only to the effects described above. Accordingly, additional effects of the present invention will be set forth in part in the description which follows and in part will become apparent to those having ordinary skill in the art upon examination of the following or may be learned from practice of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a home bar provided on a refrigerator appliance;

FIG. 2 is a perspective view illustrating a latch part according to an embodiment of the present invention;

FIG. 3 is a cross-sectional view of FIG. 2;

FIG. 4 is an exploded-perspective view of the latch part according to an embodiment of the present invention;

FIG. 5 is a perspective view illustrating a release part according to an embodiment of the present invention;

FIG. 6 is a cross-sectional view illustrating the release part according to an embodiment of the present invention;

FIGS. 7A, 7B, 7C and 7D are diagrams illustrating the release part disposed on a home bar door according to an embodiment of the present invention;

FIG. 8 is a diagram illustrating the latch part and the release part being operated together in accordance with an embodiment of the present invention;

FIGS. 9A, 9B and 9C are diagrams illustrating a process in which a device for locking the home bar door of a refrigerator according to the embodiment of the present invention is operated to open the home bar door; and

FIGS. 10A, 10B and 10C are diagrams illustrating a process in which the device for locking the home bar door of a refrigerator according to the embodiment of the present invention is operated to close the home bar door.

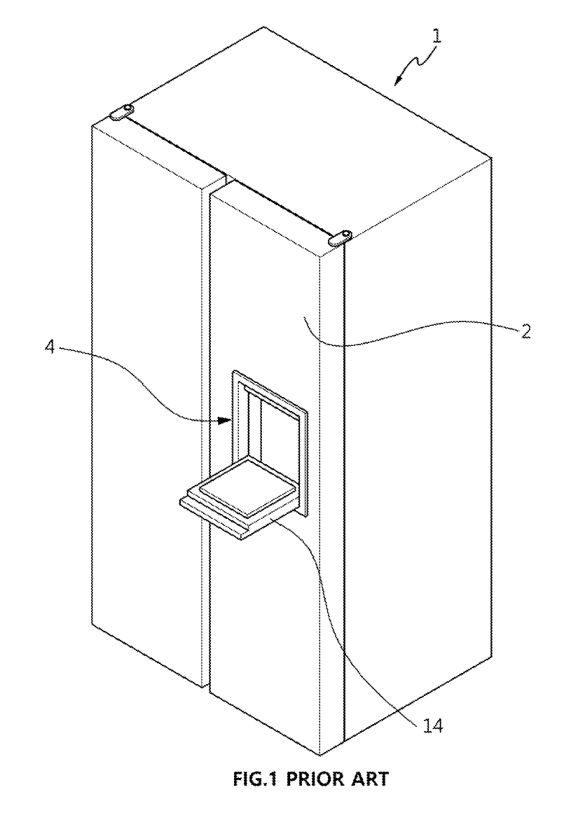

### DESCRIPTION OF THE PREFERRED EMBODIMENTS

In the following description, the structural or functional description specified to exemplary embodiments according to the concept of the present invention is intended to describe the exemplary embodiments, so it should be understood that the present invention may be variously embodied, without being limited to the exemplary embodiments. However, it should be understood that the exemplary embodiments according to the concept of the present invention are not limited to the embodiments which will be described hereinbelow with reference to the accompanying drawings, but various modifications, equivalents, additions and substitutions are possible, without departing from the scope and spirit of the invention.

It will be understood that, although the terms first, second, etc. may be used herein to describe various elements, these elements should not be limited by these terms. These terms are only used to distinguish one element, from another element. For instance, a first element discussed below could be termed a second element without departing from the teachings of the present invention. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Further, the terms used herein to describe a relationship between elements, for example, “between”, “directly between”, “adjacent”, or “directly adjacent” should be interpreted in the same manner as those described above.

Wherever possible, the same reference numerals will be used throughout the drawings and the description to refer to the same or like elements or parts. The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in this specification, specify the presence of stated features, steps, operations, elements, components, and/or combinations of them but do not preclude the presence or addition of one or more other features, steps, operations, elements, components, and/or combinations thereof.

A device for locking a home bar door of a refrigerator according to an embodiment of the present invention includes: a latch part mounted on a refrigerator door and having a locking block configured to be linearly movable in the latch part; and a release part mounted on a home bar door hinged to an opening provided in the refrigerator door, where the release part is configured to operate the latch part to move linearly, and wherein the release part is also detachably engaged with the latch part.

Hereinafter, embodiments of the present invention will be described in detail with reference to the accompanying drawings.

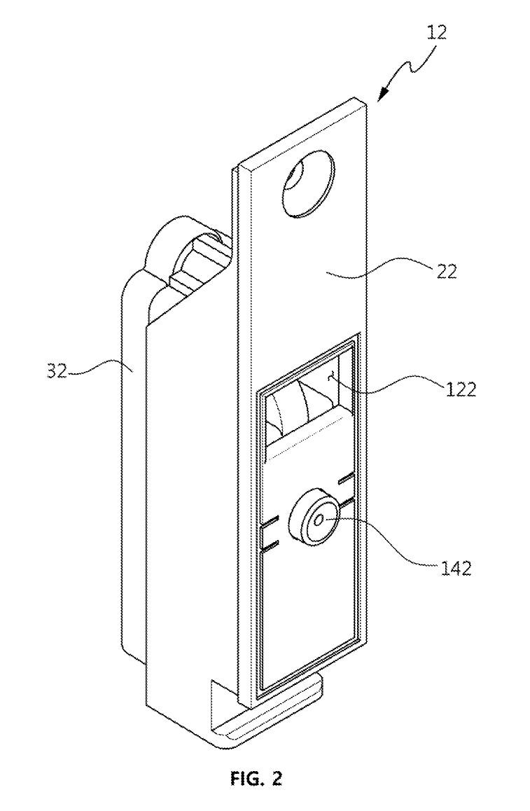

FIGS. 2 to 4 show a latch part 12 in accordance with an embodiment of the present invention. As shown in FIG. 2, the latch part 12 may include a housing 22 and a housing cover 32 that is used to cover the housing 22. The latch part 12 is mounted on a refrigerator door 2 so that the housing 22 faces the outside of the refrigerator door 2 and where the housing cover 32 is disposed at an inner side of the refrigerator door 2.

The housing 22 is provided with a fixing part to be mounted on the refrigerator door 2. In addition, the housing 22 has an opening 122 and a through hole 222, which communicate with the inside of the housing 22, on a side surface of the housing 32 facing the outside of the refrigerator door 2. Furthermore, the housing 22 has a mounting hole 322 to be engaged with the housing cover 32. A fastening member 72 is inserted in the mounting hole 322 such that the housing cover 32 is engaged with the housing 22.

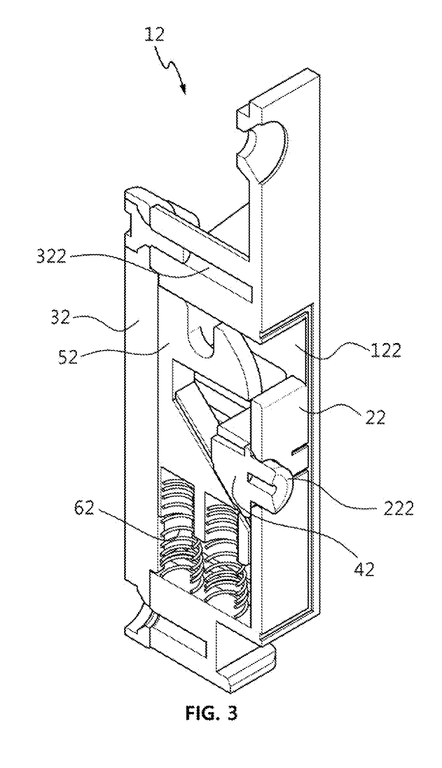

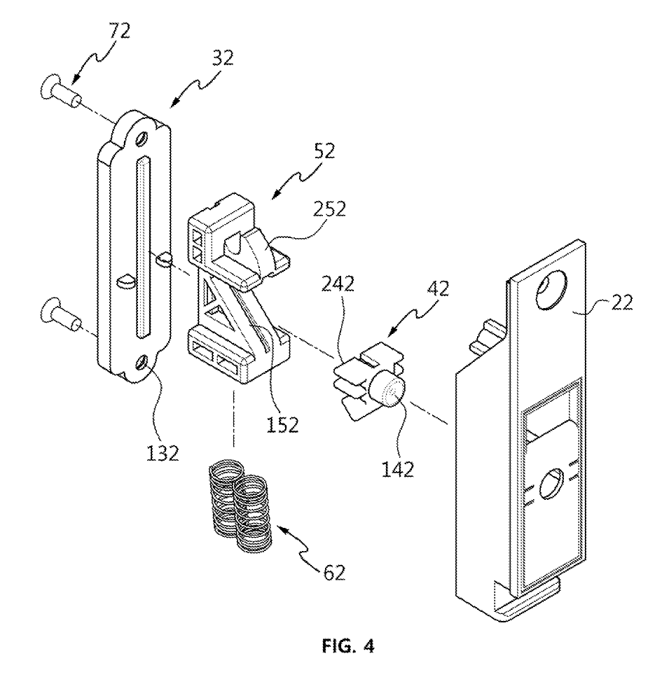

Referring to FIGS. 3 and 4, the latch part 12 includes a cam member 42, a locking block 52, and a first elastic member 62 inside the housing 22.

The cam member 42 is inserted into the through hole 222 of the housing 22 to apply pressure from the outside and includes a protrusion 142 protruding from a surface of the housing 22 toward the outside and a contact surface 242 coming into contact with the locking block 52.

The locking block 52 includes a contact portion 152 that comes into contact with the cam member 42 to transfer pressure applied to the cam member 42. The contact surface 242 of the cam member 42 and the contact portion 152 of the locking block 52 are configured into complementary shapes to slide with respect to each other when pressure is applied to the cam member 42 by pressing the protrusion 142. In other words, the contact portion 152 of the locking block 52 is configured to slide on the contact surface 242 of the cam member 42 and the locking block 52 is configured to move in a direction perpendicular to the direction of movement of the cam member 42, when the pressure is applied to the cam member 42.

In addition, the locking block 52 may include a grip 252. The grip 252 is detachably engaged with an engaging portion 126 of a release part 16. The engaging portion 126 is inserted through the opening 122 of the housing 22 to engage with the locking block 52 provided inside the housing 22.

The first elastic member 62 is disposed in connection with the locking block 52 to provide a restoring force to the cam member 42 and the locking block 52. An elastic member may be an elastic body such as a spring having a restoring force, and is referred to herein as the first elastic member 62 to distinguish it from an elastic member 56 of the release part 16 in accordance with an embodiment of the present invention. Although a pair of elastic members is shown in the drawing, the number of the elastic members used could be more or less in accordance with the present invention. The first elastic member 62 contracts due to the pressure, which is transferred through the locking block 52 by a press to the cam member 42, and when the pressure applied to the cam member 42 is released, the first elastic member 62 expands such that the locking block 52 is restored in place.

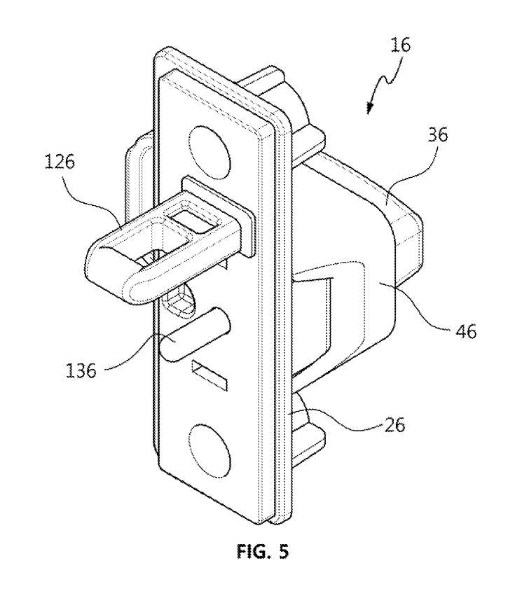

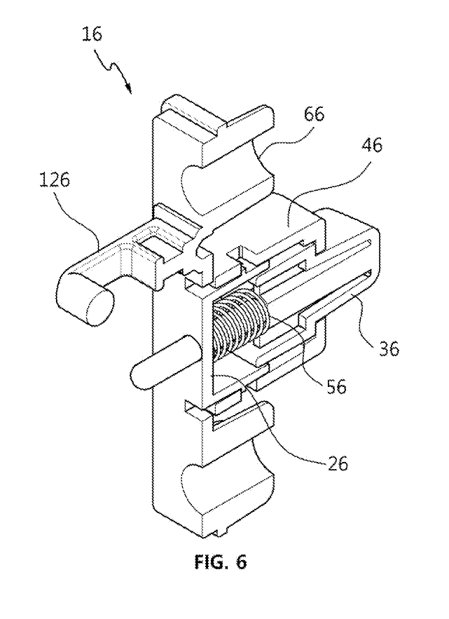

FIGS. 5 and 6 show the release part 16 in accordance with an embodiment of the present invention. The release part 16 is mounted inside the home bar door 14 of a refrigerator 1 and configured to operate with the latch part 12 in a cooperative manner.

The release part 16 may be provided with a body 26 having a mounting portion 66 to be mounted inside the home bar door 14.

The release part 16 includes pin members provided on a side surface of the body 26. The pin members may include a button 36 and a rod 136 extending from the button 36. The rod 136 of the pin members extends through the body 26 to the opposite side of the body 26. The rod 136 of the pin members is provided with a second elastic member 56 on an outer circumferential surface thereof to contract when a pressure is applied to the button 36 and to restore the button 36 when pressure is released. In addition, the button 36 is mounted on a button-securing portion 46 to prevent detachment thereof.

The release part 16 also includes the engaging portion 126 on an opposite side of the body 26. The engaging portion 126 extends outwardly from the surface of the body 26 and extends further than the rod 136. The engaging portion 126 is shaped to correspond to a shape of the grip 252 to engage with the grip 252. According to an example, as shown in FIG. 5, the engaging portion 126 is a bar protruding from the surface of the body 26, and the bar has a through-surface or open portion. Correspondingly, the grip 252 may be a hook-shaped configuration that fits in the through-surface (open portion) of the bar and is engaged to an end of the bar.

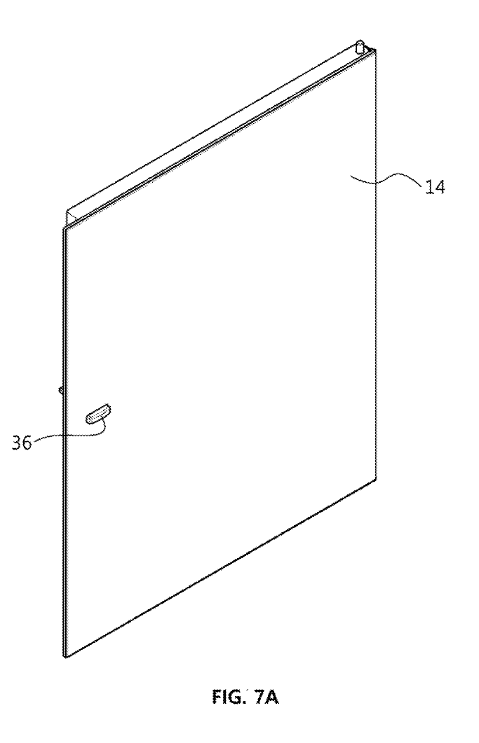

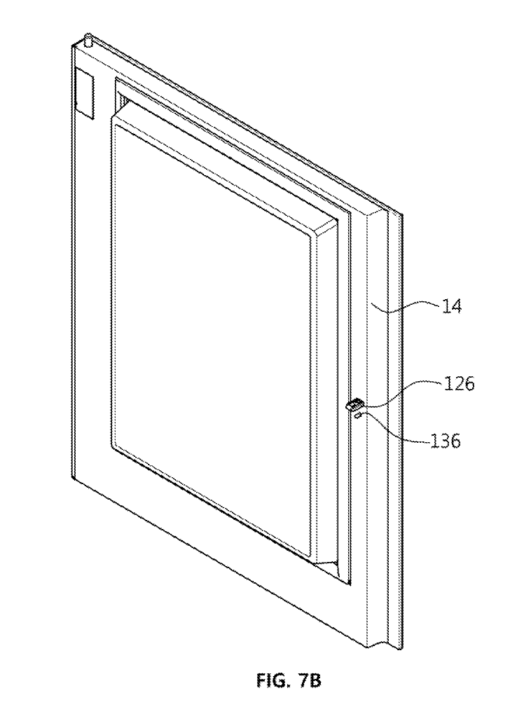

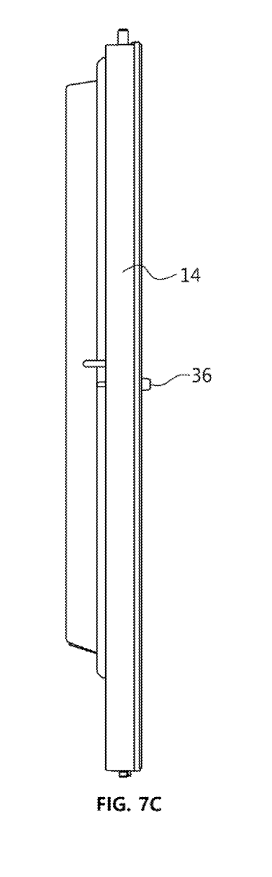

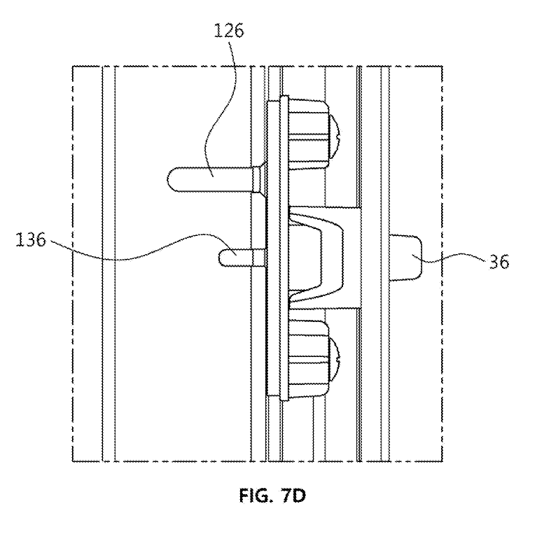

Hereinafter, the configuration in which the release part 16 is mounted on the home bar door 14 will be described. FIGS. 7A to 7D show the release part 16, which is mounted on the home bar door 14. As shown in FIG. 7A, the release part 16 is mounted in a manner that only the button 36 protrudes toward the outside of the home bar door 14. As shown in FIG. 7B, the engaging portion 126 and the rod 136 protrude toward the inside of the home bar door 14. FIGS. 7C and 7D show side views of the home bar door 14 in which the release part 16 is provided inside the home bar door 14.

Hereinafter, an operation of the device for locking the home bar door of the refrigerator according to the present invention will be described.

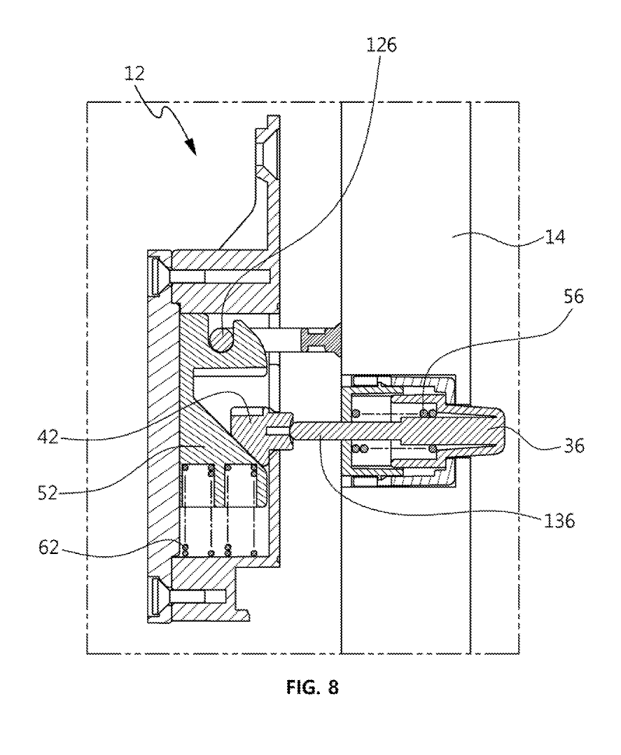

Referring to FIG. 8, the latch part 12 is mounted on the refrigerator door 2 to operate in conjunction with the release part 16 in a cooperating manner, the release part 16 is mounted on the home bar door 14 of FIGS. 7A to 7D.

FIG. 8 shows the home bar door 14 being closed. When the home bar door 14 is closed, the cam member 42 of the latch part 12 and the rod 136 of the release part 16 are in contact with each other, and the engaging portion 126 of the release part 16 is engaged with the grip 252 of the locking block 52.

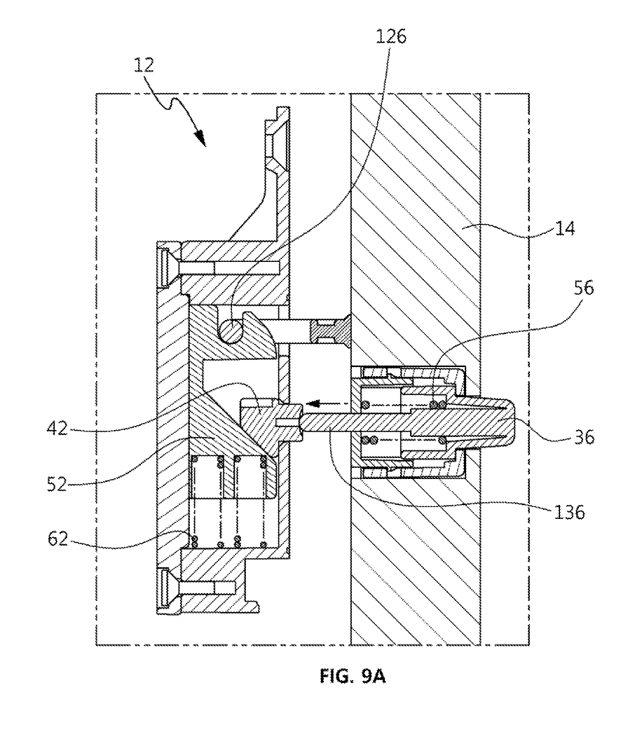

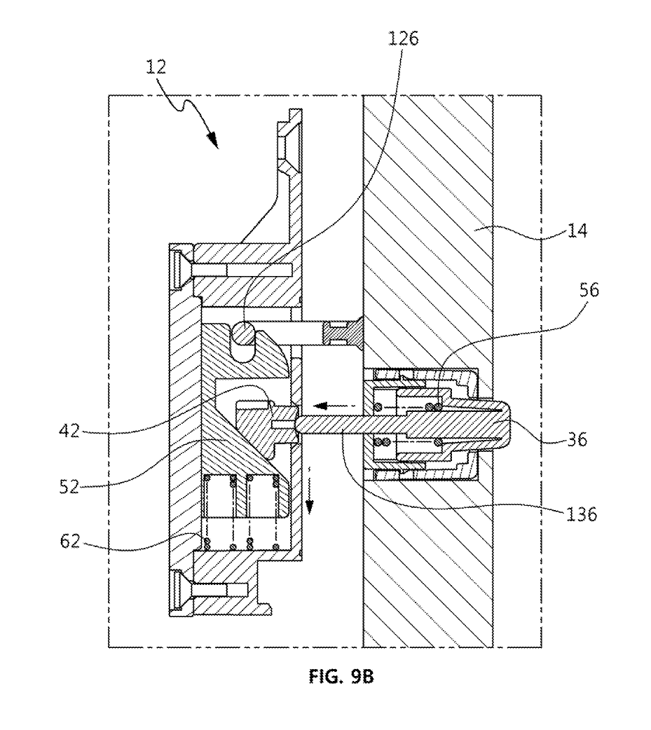

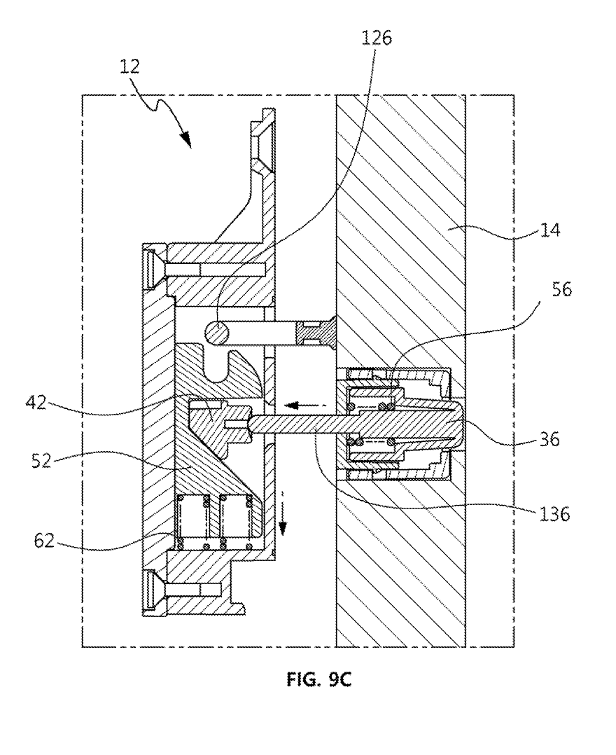

FIGS. 9A to 9C show that the home bar door 14 is opened at the state in which the home bar door 14 of FIG. 8 is closed. The rod 136 presses the cam member 42 when the button 36 (protruding outside the home bar door 14) is pressed. The pressed cam member 42 slides along the contact portion 152 of the locking block 52 and the locking block 52 moves downward. As the locking block 52 moves, the engaging portion 126 is gradually separated from the grip 252 and thus the first elastic member 62 becomes compressed. When the cam member 42 moves to an end of the contact portion 152, the first elastic member 62 is completely compressed and the engaging portion 126 is completely separated from the grip 252 and the home bar door 14 is opened.

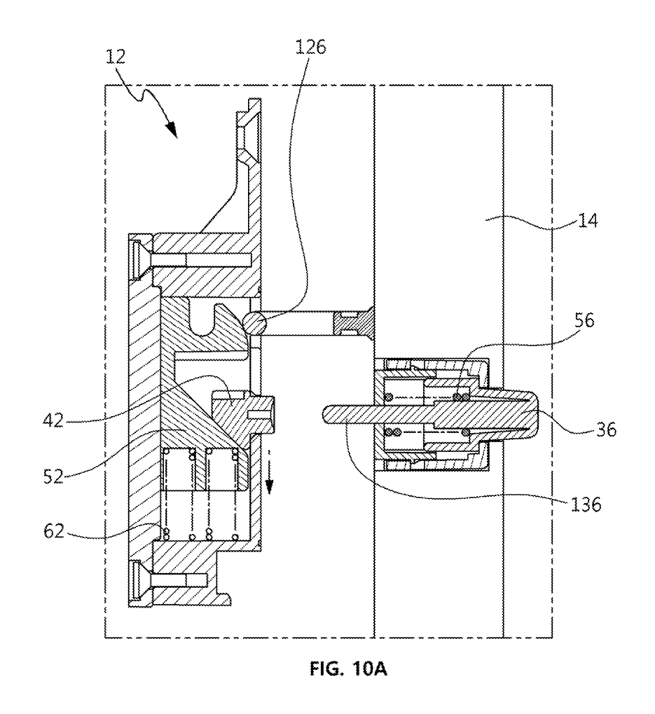

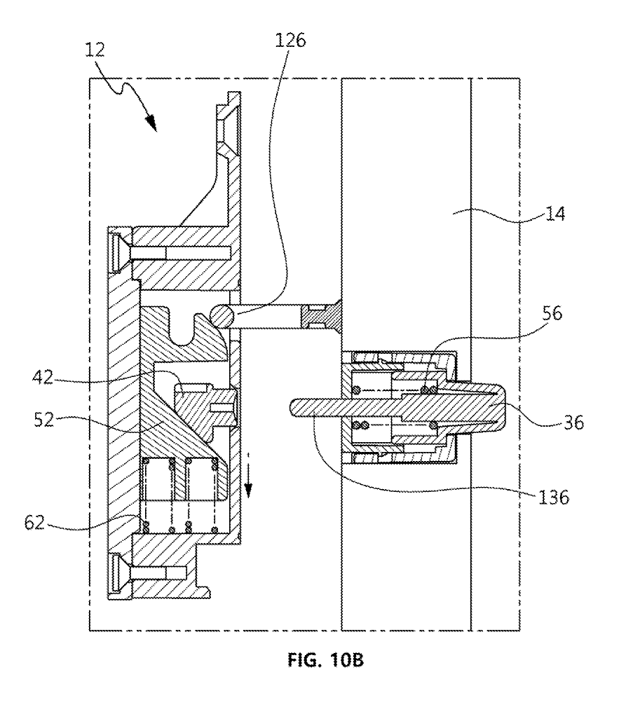

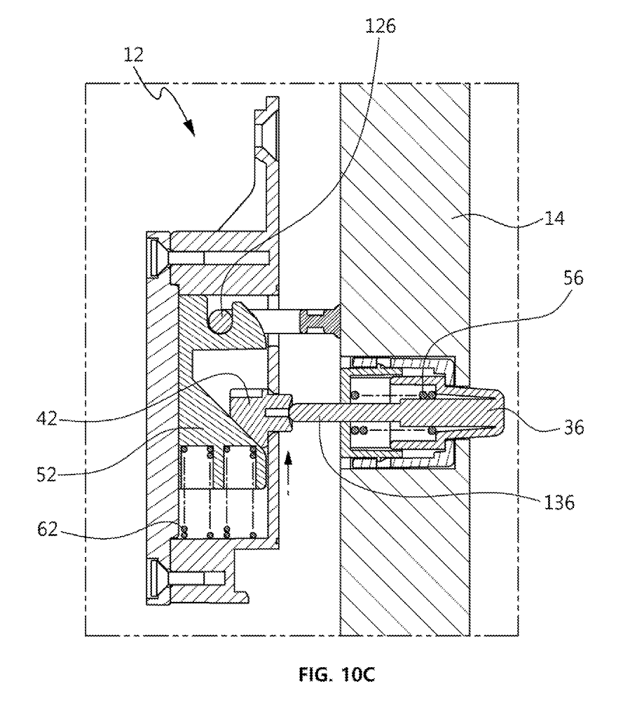

As shown in FIGS. 10A to 10D, an operation in which the open home bar door 14 is closed is as follows. When the home bar door 14 is brought close to the refrigerator door 2, the engaging portion 126 comes in contact with the grip 252. The engaging portion 126 slides on the grip 252 and provides a downward force to the locking block 52, and thus the first elastic member 62 is compressed. When the home bar door 14 is completely closed, the grip 252 and the engaging portion 126 are completely engaged. In addition, the rod 136 is brought into contact with the cam member 42, and the first elastic member 62 is in the initial state.

Although the embodiments of the present invention have been disclosed with reference to the accompanying drawings for illustrative purposes, those skilled in the art will appreciate that various modifications, additions and substitutions are possible, without departing from the scope and spirit of the invention as disclosed in the accompanying claims. It is thus well known to those skilled in that art that the present invention is not limited to the embodiment disclosed in the detailed description, and the patent right of the present invention should be defined by the scope and spirit of the invention as disclosed in the accompanying claims.

What is claimed is:

1. A device for locking a home bar door of a refrigerator, the device comprising:
a latch part configured to be mounted on a refrigerator door and comprising a locking block configured to be linearly movable in the latch part; and
a release part mounted on the home bar door wherein the home bar door is configured to be hinged to an opening provided in the refrigerator door, wherein the release part is configured to operate the latch part to move linearly, and wherein the release part is further detachably engaged with the latch part.

2. The device of claim 1, wherein the locking block is configured to move vertically.

3. The device of claim 1, wherein the latch part further comprises a cam member operable to linearly move the locking block responsive to a press thereon.

4. The device of claim 1, wherein the release part further comprises an engaging portion detachably engaged with the locking block.

5. The device of claim 4, wherein the locking block further comprises a grip configured to engage with the engaging portion.

6. The device of claim 3, wherein the latch part further comprises an elastic member configured to restore a position of the locking block responsive to a release of the press.

7. The device of claim 5, wherein the release part further comprises a pin member contacting the cam member to press the cam member.

8. A device for locking a home bar door of a refrigerator, the device comprising:
a latch part mounted on a refrigerator door; and
a release part mounted on a home bar door wherein the home bar door is hinged to an opening provided in the refrigerator door,
wherein the latch part comprises:
a locking block configured to be linearly movable;
a cam member contacting the locking block and configured to linearly move the locking block responsive to a press thereon; and
an elastic member restoring a position of the locking block responsive to a release of the press, and wherein
the release part comprises:
a pin member contacting the cam member to press the cam member; and
an engaging portion detachably engaged with the locking block.

9. The device of claim 8, wherein the cam member and the locking block move in directions that are perpendicular to each other.

10. The device of claim 8, wherein the locking block further comprises:
a contact surface in contact with the cam member; and
a grip configured to engage with the engaging portion.

11. A refrigerator appliance comprising:
a main body;
a refrigerator door mounted to the main body;
a home bar door; and
a device for locking the home bar door, wherein the device comprises:
a latch part configured to be mounted on the refrigerator door and comprising a locking block configured to be linearly movable in the latch part; and
a release part mounted on the home bar door wherein the home bar door is configured to be hinged to an opening provided in the refrigerator door, wherein the release part is configured to operate the latch part to move linearly, and wherein the release part is further detachably engaged with the latch part.

12. The refrigerator appliance of claim 11, wherein the locking block is configured to move vertically.

13. The refrigerator appliance of claim 11, wherein the latch part further comprises a cam member operable to linearly move the locking block responsive to a press thereon.

14. The refrigerator appliance of claim 11, wherein the release part further comprises an engaging portion detachably engaged with the locking block.

15. The refrigerator appliance of claim 14, wherein the locking block further comprises a grip configured to engage with the engaging portion.

16. The refrigerator appliance of claim 13, wherein the latch part further comprises an elastic member configured to restore a position of the locking block responsive to a release of the press.

17. The refrigerator appliance of claim 15, wherein the release part further comprises a pin member contacting the cam member to press the cam member.
